(19) United States
(12) Patent Application Publication
(10) Pub. No.: US 2020/0134221 A1
(43) Pub. Date: Apr. 30, 2020

(54) SYSTEM AND METHOD FOR BLOCKCHAIN DOCUMENT ACCESS AND DISTRIBUTION CONTROL

(71) Applicant: Toshiba TEC Kabushiki Kaisha, Shinagawa-ku (JP)

(72) Inventors: William SU, Riverside, CA (US); Jia ZHANG, Irvine, CA (US)

(21) Appl. No.: 16/170,588

(22) Filed: Oct. 25, 2018

(51) Int. Cl. G06F 21/62; H04L 9/08; H04L 9/06; G06F 17/30

(52) U.S. Cl. CPC G06F 21/6227; H04L 9/0819; H04L 9/3247; G06F 17/30011; G06F 17/30377; H04L 9/0637

(57) ABSTRACT

A system and method for blockchain document access and distribution control includes a processor, associated memory and a network interface for data communication with a server system. An interface receives a query for access to an electronic document associated with a blockchain ledger, which query is routed to the server system via the network interface. The processor receives the identified electronic document from a storage location when access permission is granted and a corresponding update of the blockchain ledger is made.

### TECHNICAL FIELD

This application relates generally to blockchain controlled access to stored electronic documents. The application relates more particularly to securely controlling access to distributed electronic documents by use of blockchain document inventory.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Given the expense in obtaining and maintain MFPs, devices are frequently shared via a data network. MFPs, while moveable, are generally maintained in a fixed location. Until more recent times, users, which may include individuals or groups such as employees, administrators or technicians administrators of networked MFPs, were also generally in relatively fixed location. A user would typically communicate documents or other information from his or her office or workstation.

Once created, electronic documents are typically stored in a user's device, on an MFP or on a networked fileserver. Stored documents may be accessible to anyone on a network. In certain situations, such in the case of documents including sensitive or personal information, access may be restricted.

### BRIEF DESCRIPTION OF THE DRAWINGS

Various embodiments will become better understood with regard to the following description, appended claims and accompanying drawings wherein:

FIG. 1 is an example embodiment of a blockchain document access management and access control system;

FIG. 2 is an example embodiment of a multifunction peripheral device;

FIG. 3 is an example embodiment of a digital device;

FIG. 4 is a flowchart of an example embodiment of a secure, blockchain-based document access control and management system; and

FIG. 5 is an example embodiment of a software module for a secure, blockchain-based document access control and management system.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

In accordance with an example embodiment of the subject application, a system and method for blockchain document access and distribution control includes a processor, associated memory and a network interface for data communication with a server system. An interface receives a query for access to an electronic document associated with a blockchain ledger, which query is routed to the server system via the network interface. The processor receives the identified electronic document from a storage location when access permission is granted and a corresponding update of the blockchain ledger is made.

As described herein, an example embodiment includes a system comprising a processor, associated memory and a network interface for data communication with a server system comprised of at least one associated networked server. An interface receives a query for access to an electronic document associated with a blockchain ledger. The request is routed to the server system via the network interface. The processor sends an access request to the server system for access to the identified electronic document. The processor receives the identified electronic document from a storage location when access permission is obtained from the server system. The processor commences an update of the blockchain ledger relative to access to the received electronic document.

As noted above, electronic documents are frequently stored for future access. Electronic documents may take a variety of forms, including a myriad of text based file formats, image based file formats and raster based file formats, or hybridized file formats. Documents can be stored on a user's device, on one or more MFPs, or one or more fileservers. Larger enterprises may have two or more locations. Often times, each location may operate as its own subnet. A user may not be able access electronic documents that are stored in various ways at another location. In such an instance, documents may be routed to a commonly accessible fileserver. However, a company may wish to limit access to certain of these documents, such as to certain individuals, groups or locations. Decisions as to whether access is permitted can vary.

Document accessibility may depend on factors such as a requester's location, identity or title. Accessibility may also depend on time factors, such as being available during a particular time window.

In certain example embodiments described herein, electronic documents are stored in a commonly accessible location. Each document is provided with a series of electronic blocks, referred to as a blockchain, containing a cryptographic hash of a previous block, a timestamp and transaction data corresponding to a transaction performed on the electronic document. A well understood example of blockchains is by their use in connection with Bitcoin. Blockchains are distributed among a plurality of data devices to ensure consensus based access.

Unauthorized access or modification of critical defense infrastructure, such as network firmware and operating systems, could seriously compromise company security. For most companies, computer systems and defense infrastructure are distributed across different locations. Blockchain technology distributed across multiple data centers can ensure security against attacks on important network and hardware equipment by ensuring consensus-based access for modification.

In certain example embodiments, the use of blockchains frees a main office from having to gather documents from a branch office to share with their stakeholders. A single storage location is suitably provided for all office documents which is easily accessible through granted access. This ultimately frees the main office from needing to manually manage the documents from each branch office. The main office retains access to its own company documents.

Example embodiments herein provide a blockchain solution to secure documents within an office document exchange. This will effectively deliver documents in a consistent and real-time manner, and permit access via a smart contract after main office authorization. A controlled office document exchange provides an optimized environment where document access is structured and secured. Use of digital signatures on blockchain based scanned documents allows access and printing, for example, only when authorized by multiple people who regulate availability and maintain the privacy of documents. Documents access is enabled to be in real time from anywhere. If a node/version is tampered with by any user in the network, such tampering may be readily detected so data access is transparent, consistent and secure.

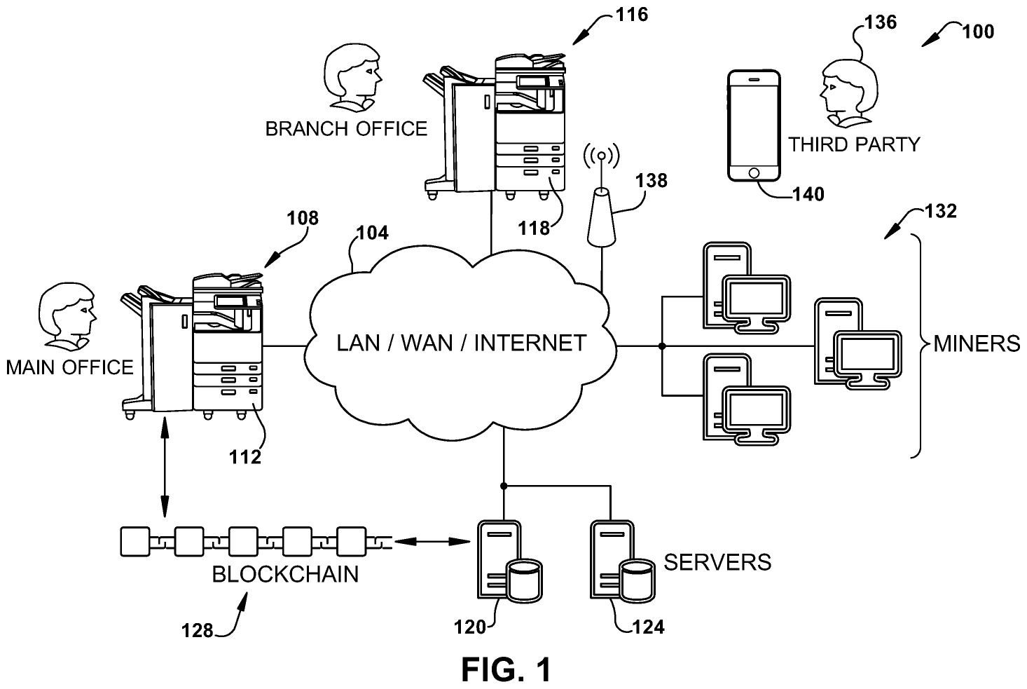

In accordance with the subject application and commensurate with the forgoing, FIG. 1 illustrates an example embodiment of a blockchain document access management and access control system 100. A data network cloud 104 is suitably comprised of any wired or wireless network, including a local area network (LAN) or wide area network (WAN), which may comprise the global Internet, or any suitable combination thereof. A main office 108, suitably comprised of one or more data devices such as MFP 112, communicates with one or more branch offices 116, through a suitable digital device, such as MFP 118 via network cloud 104. Electronic documents are suitably encrypted and stored in one or networked servers associated with one or more offices, such as server 120 or server 124. Such servers 120, 124 also suitably maintain blockchain 128 associatively with stored electronic documents. When someone from branch office 116 desires access to an electronic document, a request is made and routed to main office 108. If permission is granted, the document is decrypted with a suitable key and associated blockchain 128 is updated, suitably with a block provided by one or more networked block miners 132. One or more networked data devices are also suitably employed to maintain block ledgers to provide for confirmed transactions and block updating.

In addition to controlled and secure document access by one or more branch offices, individual requests for access may be made for third parties, such as third party 136 via any suitable data device, such as smartphone 140. For example, the third party 136 may perform a document request from their smartphone 140 using wireless access provided by access point 138.

As will be described further below, a requesting location, group or individual may also be suitably pre-authorized for document access to avoid a necessity of requesting permission each time access is desired. Even with pre-authorization, block chains are suitably updated to maintain an accurate access record.

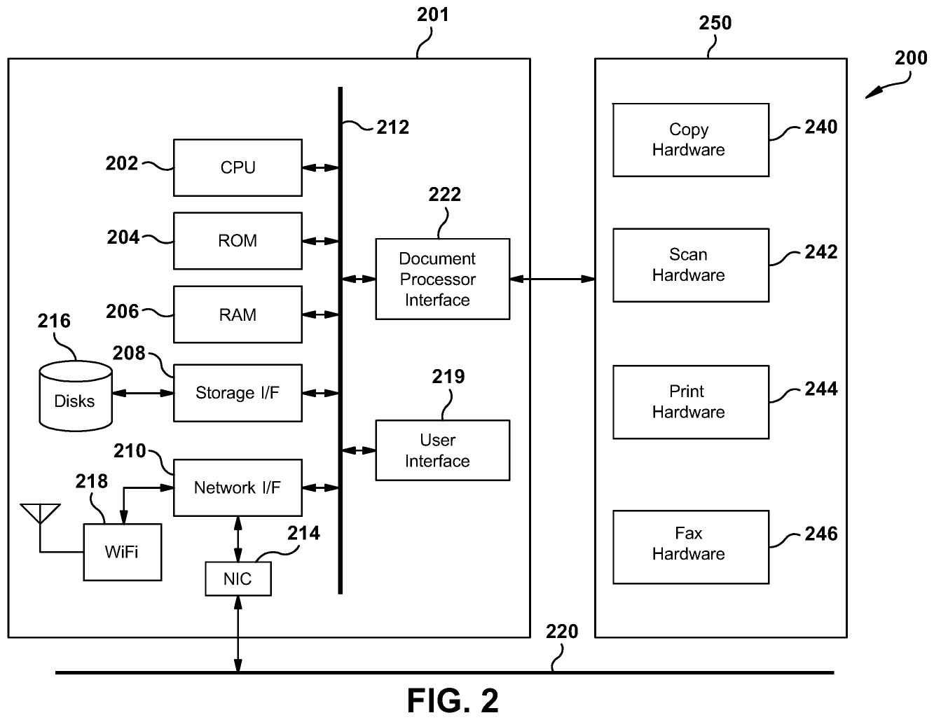

Turning now to FIG. 2 illustrated is an example embodiment of a MFP device comprised of a document rendering system 200 suitably comprised within an MFP, such as with MFPs 112 or 118 FIG. 1. Included in intelligent controller 201 are one or more processors, such as that illustrated by processor 202. Each processor is suitably associated with non-volatile memory, such as ROM 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via wireless network interface 218. Example wireless connections include cellular, Wi-Fi, Bluetooth, NFC, wireless universal serial bus (wireless USB), satellite, and the like. Example wired interfaces include Ethernet, USB, IEEE 1394 (FireWire), Lightning, telephone line, or the like. Processor 202 is also in data communication with one or more sensors which provide data relative to a state of the device or associated surroundings, such as device temperature, ambient temperature, humidity, device movement and the like.

Processor 202 can also be in data communication with any suitable user input/output (I/O) interface 219 which provides data communication with user peripherals, such as displays, keyboards, mice, track balls, touch screens, or the like. Hardware monitors suitably provides device event data, working in concert with suitable monitoring systems. By way of further example, monitoring systems may include page counters, sensor output, such as consumable level sensors, temperature sensors, power quality sensors, device error sensors, door open sensors, and the like. Data is suitably stored in one or more device logs, such as in storage 216 of FIG. 2.

Also in data communication with data bus 212 is a document processor interface 222 suitable for data communication with MFP functional units 250. In the illustrated example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

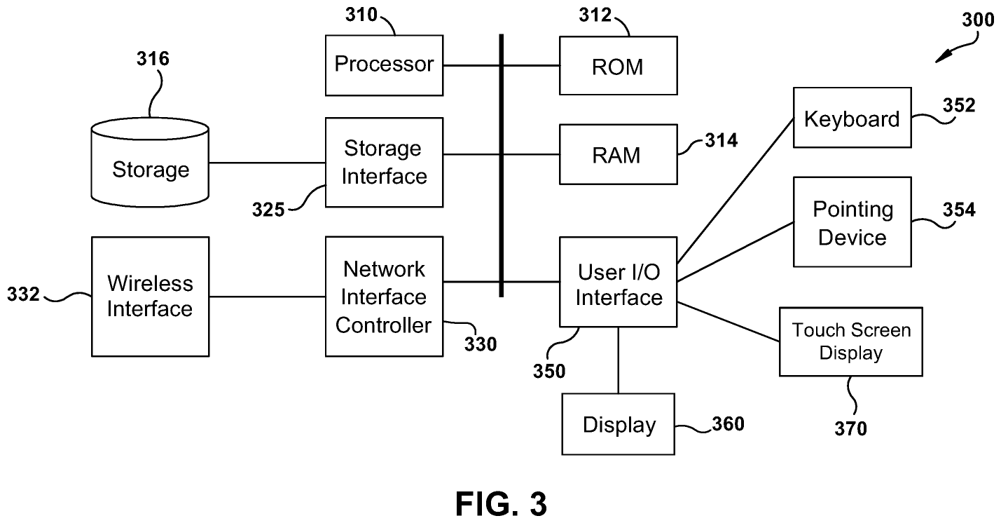

Turning now to FIG. 3, illustrated is an example embodiment of a suitable digital device 300 such server computers 120 or 124, block miner computers 128 or smartphone 140. Included are one or more processors, such as that illustrated by processor 310. Each processor is suitably associated with non-volatile memory, such as read only memory (ROM) 312 and random access memory (RAM) 314, via a data bus.

Processor 310 is also in data communication with a storage interface 325 for reading or writing to a data storage system 316, suitably comprised of a hard disk, optical disk, solid-state disk, or any other suitable data storage as will be appreciated by one of ordinary skill in the art.

Processor 310 is also in data communication with a network interface controller (NIC) 330, which provides a data path to any suitable wired or physical network connection via physical network interface, or to any suitable wireless data connection via wireless interface 332, such as one or more of the networks detailed above. The system suitably uses location based services.

Processor 304 is also in data communication with a user input/output (I/O) interface 350 which provides data communication with user peripherals, such as display 360, as well as keyboards 352, mice, track balls, or other pointing devices 354, touch screen 370, or the like. It will be understood that functional units are suitably comprised of intelligent units, including any suitable hardware or software platform.

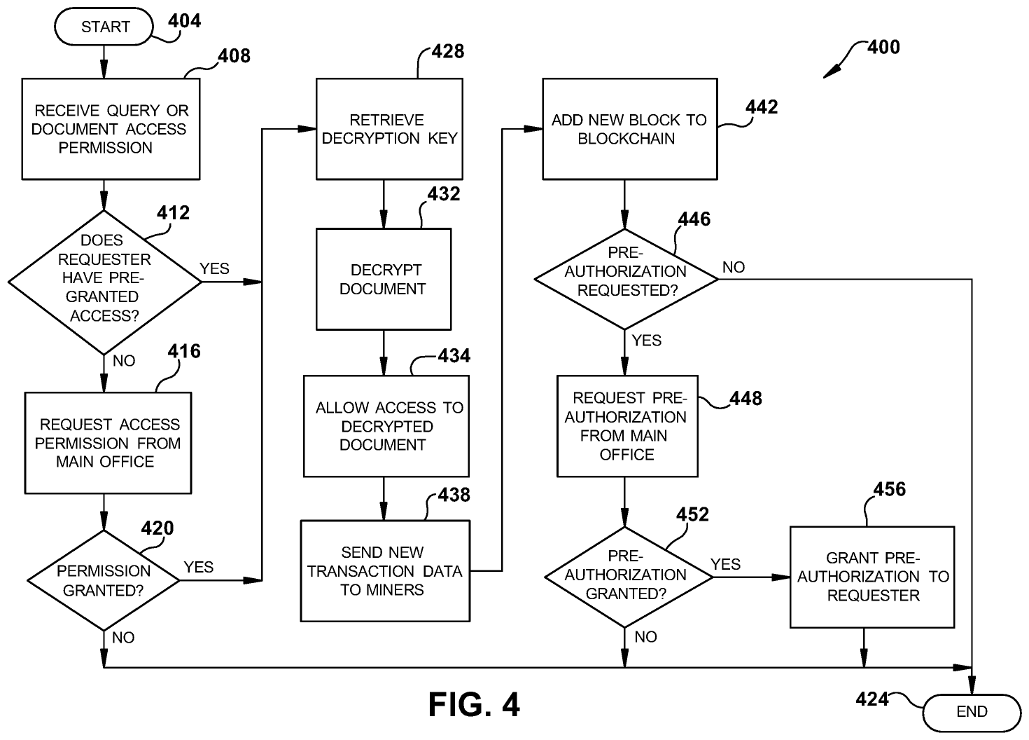

FIG. 4 is a flowchart 400 of an example embodiment of a secure, blockchain based document access control and management system. The process commences at block 404 and proceeds to block 408 when a query for document access is received. A determination is made at block 412 as to whether the requestor has pre-granted access. If not, access permission is requested from the main office at block 416. If permission is not granted at block 420, the process ends at block 424. If permission is granted, a decryption key is retrieved at block 428. If it was determined that the requester had pre-granted access at block 412, the process proceeds directly to block 428 to retrieve the decryption key.

Once the decryption key has been obtained at block 428, the document is decrypted at block 432 and access is allowed at block 434. New transaction data is sent to block miners at block 438 to secure an updated block for the associated blockchain, and the new block is added at block 442. A check is made as to whether preauthorization was requested at block 446. If not, the process ends at block 424. If so, permission is sought from the main office at block 448. If permission is granted at block 452, the requester is marked with pre-granted access at block 456 and the process then ends at block 424. If permission is not granted, the process ends at block 424 directly from block 452.

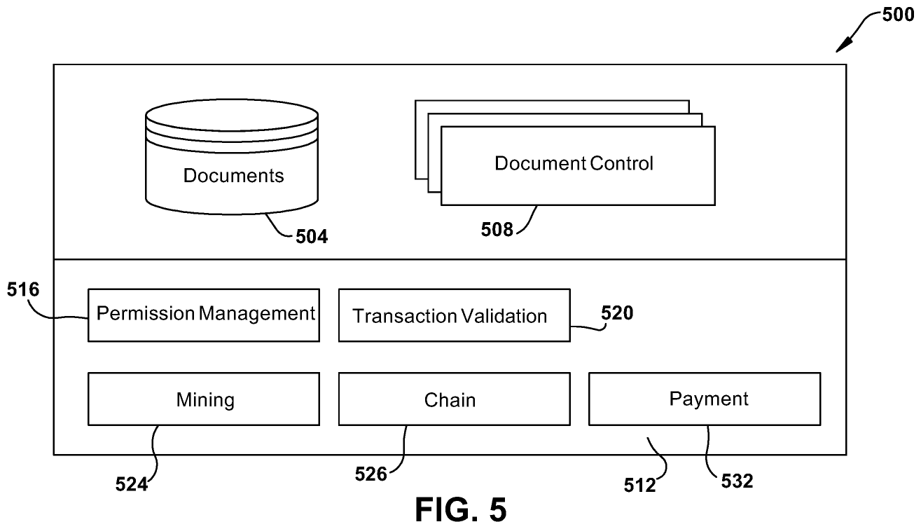

FIG. 5 is an example environment of a software module block diagram 500 commensurate with the forgoing. Documents 504 are controlled by document control module 508. Blockchain connector module 512 suitably comprises permission management module 516, transaction validation module 520, mining module 524, chain module 528 and payment module 532.

The above-described modules facilitate a data flow and transaction process that provides for data security along with ease of access and efficiency on the cloud. A network process is suitably divided into three sub-procedures.

Scan (Data Input)—When branch office scans a document, an NFP connects to the cloud. The document is indexed on the cloud and keywords are matched. So while the actual documents on the branch office, the application has the indices and decryption keys to the document.

Print (Data Access)—When another branch office searches for specific categories of documents, the application search engine algorithms search the indices and fetches the source locations for the type of document the branch office queried. The branch office can then submit a request to the main office to grant the access.

Granting Permissions—When a new access request is submitted, the cloud engine reaches out to involved participants for a digital network operating center (NoC) in form of a smart contract. When the access request is approved by both the parties, the request is granted and all the asked documents are made available to the branch office.

An associated engine suitably also provides for pre-granted access rights. When a branch office joins the network, they are asked if they want to join a specified data exchange program. If they agree, their information is suitably flagged as “Always Accessible” facilitating a streamlining of future access.

Using digital signatures on blockchain-based scanned document facilitates access or printing only when authorized by multiple people which functions to regulate availability and maintain the privacy of documents. Documents can be available in real-time and worldwide.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
a network interface configured for data communication with a server system comprised of at least one associated networked server;
an interface configured to receive a query for access to an electronic document associated with a blockchain ledger; and
a processor and associated memory,
the processor configured to route a received query to the server system via the network interface,
the processor further configured to send an access request to the server system for access to the identified electronic document,
the processor further configured to receive the identified electronic document from a storage location when access permission is obtained from the server system, and
the processor further configured to commence an update of the blockchain ledger relative to access to the received electronic document.

2. The system of claim 1 wherein the identified electronic document is digitally signed.

3. The system of claim 2 wherein the identified electronic document is encrypted.

4. The system of claim 3 wherein the processor is further configured to decrypt the electronic document in accordance with one or more decryption keys.

5. The system of claim 4 further wherein the processor is further configured to receive at least one decryption key via the network interface.

6. The system of claim 5 further comprising:
an input configured to receive an incoming electronic document, and
wherein the processor is further configured to commence an indexing of content in the incoming electronic document,
wherein the processor is further configured to commence generation of an encryption key for the incoming electronic document,
wherein the processor is further configured to store the incoming electronic document, and
wherein the processor is further configured to commence an update of the blockchain ledger relative to the incoming electronic document.

7. The system of claim 6 wherein the processor is further configured to store a generated index and a generated encryption key in the server system via the network interface.

8. A method comprising:
receiving a query for access to an identified electronic document associated with a blockchain ledger;
routing a received query to a server system via a network interface;
sending an access request to the server system for access to the identified electronic document;
receiving the identified electronic document from a storage location when access permission is obtained from the server system; and
commencing an update of the blockchain ledger relative to access to the received electronic document.

9. The method of claim 8 wherein the identified electronic document is digitally signed.

10. The method of claim 9 wherein the identified electronic document is encrypted.

11. The method of claim 10 further comprising decrypting the electronic document in accordance with one or more decryption keys.

12. The method of claim 11 further comprising receiving at least one decryption key via the network interface.

13. The method of claim 12 further comprising:
receiving an incoming electronic document;
commencing an indexing of content in the incoming electronic document;
commencing generation of an encryption key for the incoming electronic document;
storing the incoming electronic document; and
commencing an update of the blockchain ledger relative to the incoming electronic document.

14. The method of claim 13 further comprising storing a generated index and a generated encryption key in the server system via the network interface.

15. A document server system comprising:
a memory storing a blockchain corresponding to a plurality of encrypted and signed electronic documents,
the memory further storing keyword data associatively with each of the electronic documents, and
the memory further storing at least one decryption key for the electronic documents;
a network interface configured to receive search query from an associated data device; and
a processor,
the processor configured to identify at least one of the electronic documents responsive to a received query,
the processor configured to output a document permission request for access to an identified electronic document, and
the processor further configured to commence an update of the blockchain relative to access to the identified document.

16. The system of claim 15 wherein the processor is further configured to access a decryption key corresponding to the identified document responsive to the query.

17. The system of claim 16 wherein the processor is further configured to pre-certify the associated data device with permission to access at least a portion of the electronic documents.

18. The system of claim 17 wherein the processor is further configured to pre-certify a plurality of associated data devices disposed at a common location.

19. The system of claim 18 wherein the processor is further configured to pre-certify the plurality of associated data devices disposed on a common subnet.

20. The system of claim 15 further comprising the processor configured to complete the update of the blockchain in accordance with a block received from an associated block miner.
